(19) United States
(12) Patent Application Publication
(10) Pub. No.: US 2013/0144640 A1
(43) Pub. Date: Jun. 6, 2013

(54) Automated System And Method For Electronic Verification, Precertification And Appeal For Medical Benefit Denials

(71) Applicant: Julian Omidi, Las Vegas, NV (US)

(72) Inventor: Julian Omidi, Las Vegas, NV (US)

(21) Appl. No.: 13/341,936

(22) Filed: Dec. 31, 2011

Related U.S. Application Data
(60) Provisional application No. 61/429,112, filed on Dec. 31, 2010.

(51) Int. Cl. G06F 19/00; G06Q 50/22

(52) U.S. Cl. CPC G06F 19/328; G06Q 50/22
USPC 705/2

(57) ABSTRACT

The present invention is comprised of an automated system and method for electronic verification, pre-certification and appeal for medical benefit denials for providing automated medical processing to a medical or surgery center or other form of medical facility. The present invention is further comprised of a database software system to record, store and process large volumes of data. The present invention is further comprised of modules that automatically perform the processing task include preparations and automatically filing appeals for denials.

### BACKGROUND

The past few decades have seen dramatic complexity evolving in health insurance coverage. Heath care providers face hundreds of pages of plan rhetoric to decipher to get the insurance companies to agree to cover medical benefits for medical service rendered to the patient who has been paying for the insurance coverage. In growing numbers insurance companies are just flat out denying benefits citing one plan or policy issue after another. In some cases these citations are erroneous or just smoke screens to discourage medical provider from proceeding with treatments. Health care providers and their staffs are faced with devoting an ever increasing share of their work hours to manually attack the delays and denials rather than being able to use that same time with the patients for whom the health care is there to serve. An automated system for requesting and disputing denials of benefits in strict compliance with the volumes of insurance plan policies easing the processes of appeals would relieve the added staffing burden and undermine the stonewalling tactics of the erroneous delays and denials.

### BRIEF DESCRIPTION OF THE DRAWINGS

FIG. 1 shows a block diagram of an overview of an automated system and method for electronic verification, pre-certification and appeal for medical benefit denials of one embodiment of the present invention.

FIG. 2 shows a block diagram of an overview flow chart of an automated system and method for electronic verification, pre-certification and appeal for medical benefit denials and continues on FIG. 3 of one embodiment of the present invention.

FIG. 3 shows a block diagram of an overview flow chart continuing from FIG. 2 of an automated system and method for electronic verification, pre-certification and appeal for medical benefit denials and continues on FIG. 4 of one embodiment of the present invention.

FIG. 4 shows a block diagram of an overview flow chart continuing from FIG. 3 of an automated system and method for electronic verification, pre-certification and appeal for medical benefit denials of one embodiment of the present invention.

FIG. 5 shows a block diagram of a working example of an automated system and method for electronic verification, pre-certification and appeal for medical benefit denials of one embodiment of the present invention.

### DETAILED DESCRIPTION OF THE INVENTION

In a following description, reference is made to the accompanying drawings, which form a part hereof, and in which is shown by way of illustration a specific example in which the invention may be practiced. It is to be understood that other embodiments may be utilized and structural changes may be made without departing from the scope of the present invention.

### General Overview:

It should be noted that the descriptions that follow, for example, in terms of automated system and method for electronic verification, pre-certification and appeal for medical benefit denials is described for illustrative purposes and the underlying system can apply to all types of health care for health care services. In one embodiment of the present invention, the automated system and method for electronic verification, pre-certification and appeal for medical benefit denials may include customized modules and capabilities to provide automated processing of pre-certification preparation, automated appeals and other automated features and functions using the present invention.

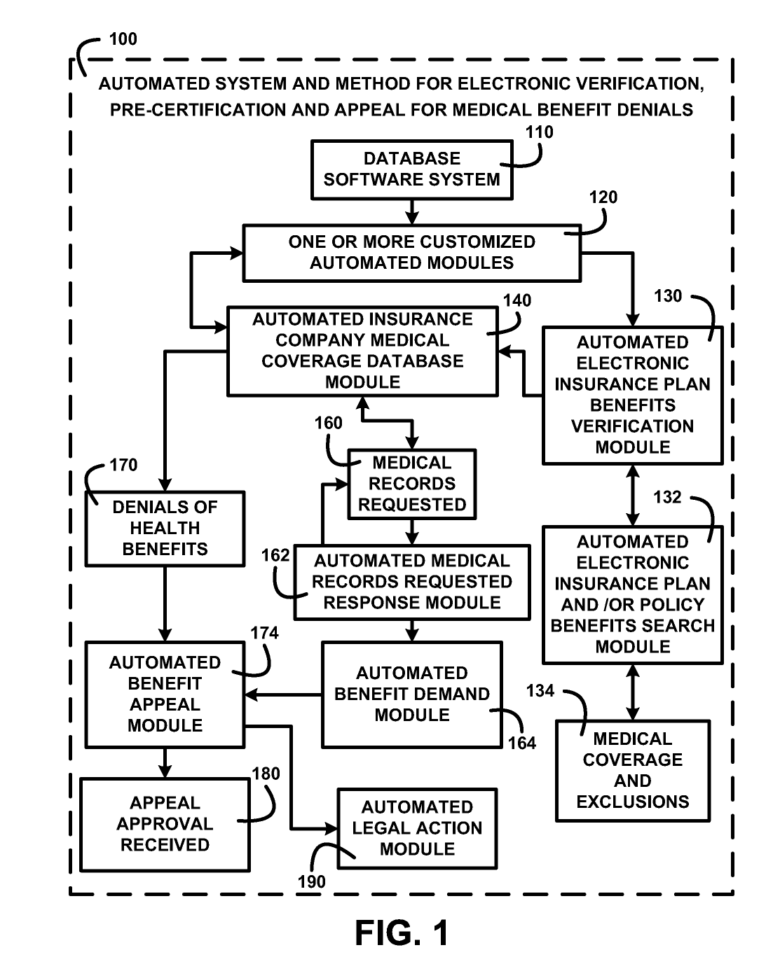

FIG. 1 shows a block diagram of an overview of an automated system and method for electronic verification, pre-certification and appeal for medical benefit denials of one embodiment of the present invention. FIG. 1 shows an automated system and method for electronic verification, pre-certification and appeal for medical benefit denials 100 configured to automatically process health insurance benefit approval submission and when is denied or delay for questionable reasons the automated processes can be configured to prepare and file electronically appeals.

The automated system and method for electronic verification, pre-certification and appeal for medical benefit denials 100 can be configured to include a database software system 110 to record and store data and operate one or more customized automated modules 120 to perform the processing functions. The one or more customized automated modules 120 can be configured to include an automated electronic insurance plan benefits verification module 130 to confirm benefits availability from the patient's insurance plan. The search of an insurance plan is continued with an automated electronic insurance plan and/or policy benefits search module 132 to find the desired medical coverage and exclusions 134 that may be applied of one embodiment of the present invention.

The one or more customized automated modules 120 can be configured to include an automated insurance company medical coverage database module 140 to prepare and send electronically at the earliest opportunity an approval request. Timely generated benefits verifications by the automated insurance company medical coverage database module 140 can result in faster processing through an insurance company of one embodiment of the present invention.

On occasions an insurance company delays medical coverage approval because of medical records requested 160 the automated medical records requested response module 162 performs a search of the database software system 110 to select the records requested and sends them electronically. The insurance companies can also make denials of health benefits 170. The automated system and method for electronic verification, pre-certification and appeal for medical benefit denials 100 can be configured to include an automated benefit appeal module 174 to prepare and file appeals using information searched from the insurance plan and/or policy on file. If the result is an appeal approval received 180 no further action takes place. If the appeal is unsuccessful one or more customized automated modules 120 can be configured to include an automated legal action module 190 to automatically prepare and file an action against the insurance company of one embodiment of the present invention.

### Detailed Operation:

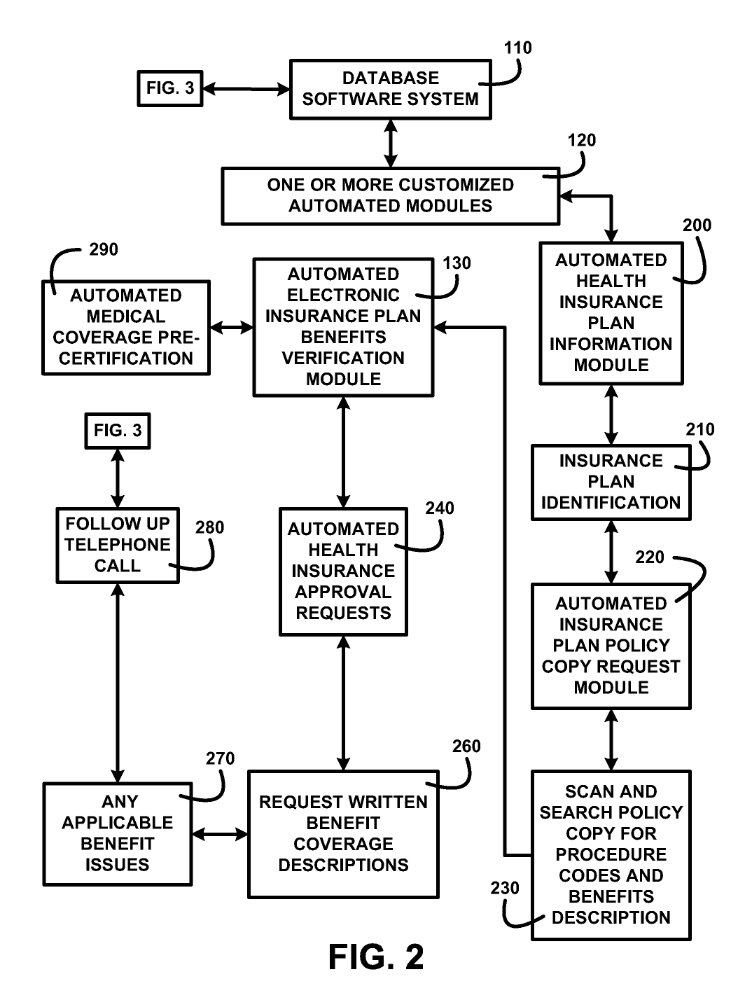

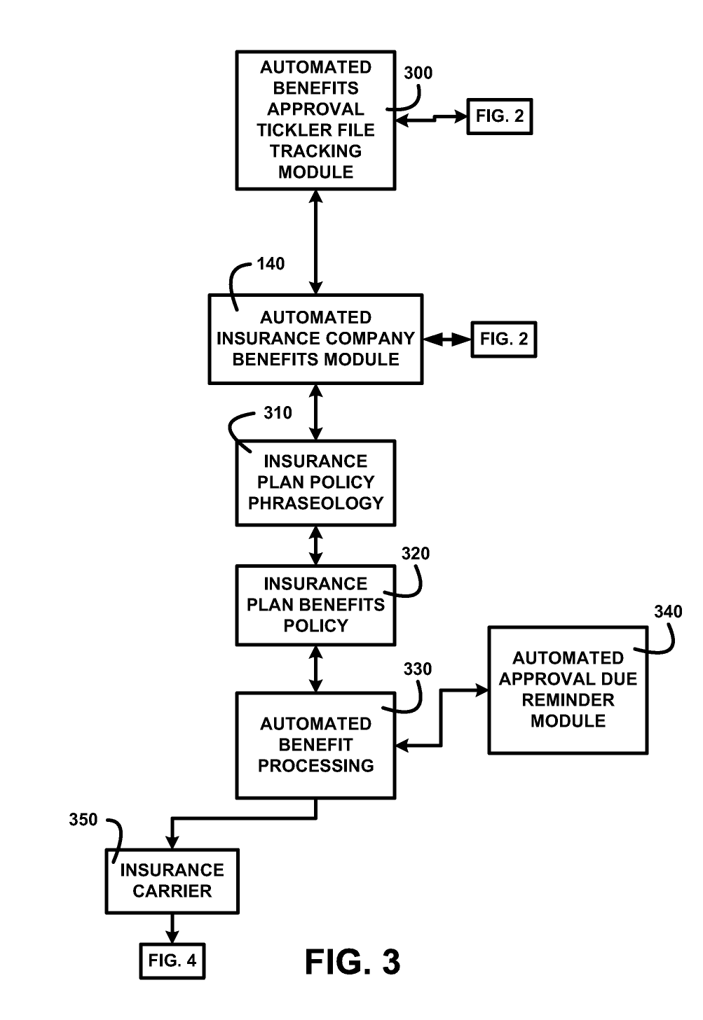

FIG. 2 shows a block diagram of an overview flow chart of an automated system and method for electronic verification, pre-certification and appeal for medical benefit denials and continues on FIG. 3 of one embodiment of the present invention. FIG. 2 shows the automated system and method for electronic verification, pre-certification and appeal for medical benefit denials 100 of FIG. 1 which can be configured to include the database software system 110. The database software system 110 can be configured to include one or more customized automated modules 120 of one embodiment of the present invention.

The one or more customized automated modules 120 can be configured to include an automated health insurance plan information module 200 to process data related to a plan and/or policy to determine the specific language of the plan and/or policy that will govern the filing of benefits. The patient should supply an insurance plan identification 210 which can be used by an automated insurance plan policy copy request module 220 to get a copy for preparation. When the plan and/or policy is received the automated system and method for electronic verification, pre-certification and appeal for medical benefit denials 100 of FIG. 1 can perform a scan and search policy copy for procedure codes and benefits description 230. The automated electronic insurance plan benefits verification module 130 can be configured to check whether the insurance plan identification provides by the patient is valid and whether the patient is covered. The one or more customized automated modules 120 can be configured to include an automated health insurance approval requests 240 module to process approvals for a medical procedure. The automated health insurance approval requests 240 module can determine planned procedure codes you intend to bill 250. This is helpful information to getting faster benefit processing. When making an approval request the automated health insurance approval requests 240 module will automatically request written benefit coverage descriptions 260 and any applicable benefits issues 270 to be made. A follow up telephone call 280 can be made to confirm electronically obtained information as a recheck process. The process continues and is further described in FIG. 3 of one embodiment of the present invention.

### Automated Insurance Company Medical Coverage Database Module:

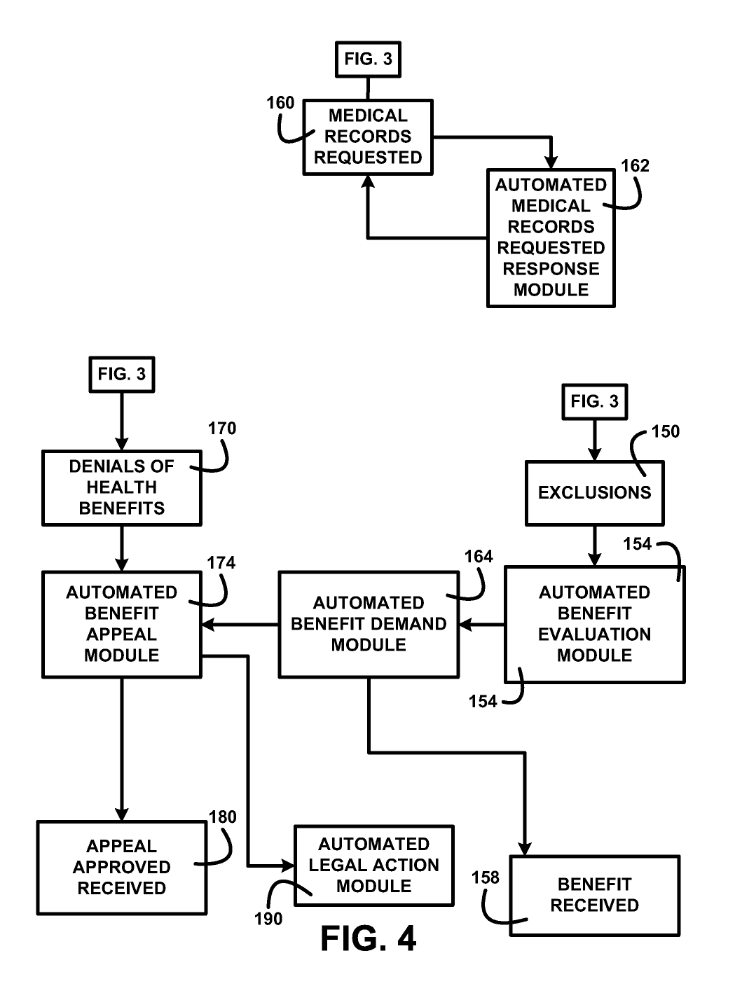

FIG. 3 shows a block diagram of an overview flow chart of an automated system and method for electronic verification, pre-certification and appeal for medical benefit denials and continues on FIG. 4 of one embodiment of the present invention. FIG. 3 shows the process continuing from FIG. 2 with an automated benefits approval tickler file tracking module 300 indicating that a procedure has been completed and is ready for processing. The automated insurance company medical coverage database module 140 receives the information from FIG. 2 and proceeds to prepare a benefit. In the preparation of the benefit the automated insurance company medical coverage database module 140 will search for and use insurance plan policy phraseology 310 scanned from an insurance plan benefits policy 320 to correctly describe the benefits, procedures and other pertinent information in the vernacular of the insurance company to prevent any misunderstandings of one embodiment of the present invention.

The automated insurance company medical coverage database module 140 prepared benefit is further processed by an automated benefit processing 330 module. The automated benefit processing 330 modules records the benefit in an automated approval due reminder module 340 and then sends electronically the benefit to the appropriate insurance carrier 350. If the insurance carrier 350 makes a timely 145 the process ends. If the insurance carrier 350 fails to make a timely 145 the process continues and is described in FIG. 4 of one embodiment of the present invention.

### Automated Benefit Appeal Module:

FIG. 4 shows a block diagram of an overview flow chart of an automated system and method for electronic verification, pre-certification and appeal for medical benefit denials and continues on FIG. 3 of one embodiment of the present invention. FIG. 4 shows the continuation of the process in FIG. 3 if the is not made. An insurance carrier 350 of FIG. 3 may delay waiting for medical records requested 160. An insurance carrier 350 of FIG. 3 has time limitations set by Federal law in which to request medical records. In this circumstance an automated medical records requested response module 162 will check if the request is within time limit send requested medical records 400. If the request is timely the automated medical records requested response module 162 will perform a search for the request medical records and forward them automatically to the insurance carrier 350 of FIG. 3. If however the request is beyond time limit do not send requested medical records and demand immediate 410 the request will be process to the automated benefit demand module 164. If the demand letter generated by the automated benefit demand module 164 produces a benefit received 158 the process stops. If not the benefit is processed to the automated benefit appeal module 174 to prepare and file an appeal. If an appeal approval received 180 is produced the process stops. If the appeal is denied and refused the automated legal action module 190 will prepare and file a legal action to secure through the courts of one embodiment of the present invention. The benefit processed in FIG. 3 may end up with the insurance carrier 350 of FIG. 3 making exclusions 150. This is processed to the automated benefit evaluation module 154. Payments from the insurance companies are generally accompanied by an EOB which stands for explanation of benefits. The explanation can provide insight into the reasons for reductions and can be used in the preparation of an appeal. The payments are also generally made electronically as a direct deposit and the automated system and method for electronic verification, pre-certification and appeal for medical benefit denials 100 of FIG. 1 can be configured to periodically search bank records electronically to locate and determine if they have been reduced. The automated reduced evaluation module 154 can be configured to accept reduced payments to meet prescribe conditions and the process can accept reduced 420. If that determination is reached the is classified as a benefit received 158 and the process ends. Should the automated reduced evaluation module 154 determine not to accept the reduced the benefit is processed to the automated benefit demand module 164 to prepare and send a demand letter which may end with a benefit received 158 and the process will end. Should no be produced by the demand process the benefit is directed to the automated benefit appeal module 174 to file an appeal which may produce an appeal approval received 180 and the process will end. If the appeal is denied the automated legal action module 190 will file a legal action to recover the balance of the reduced benefit of one embodiment of the present invention.

The billing process in FIG. 3 may result in denials of health benefits 170 which will prompt the automated benefit appeal module 174 to file an appeal to produce an appeal approval received 180 and if not process the denied benefit to the automated legal action module 190 for preparation and filing of a legal action. The automated system and method for electronic verification, pre-certification and appeal for medical benefit denials 100 of FIG. 1 processes rarely need the intervention of a staff member and can process large quantities of and the ancillary process to lead to their correct and timely submittals. The saving in staff cost, faster turn around of billable benefits, the dogged tenacity to process collections actions untiringly is beyond a reasonable persons capacity to perform day and night every day of every week. The automated processes provide a front line defense against insurance company tactics to delay or deny and put a medical or surgery center at financial risk of one embodiment of the present invention.

### Working Example:

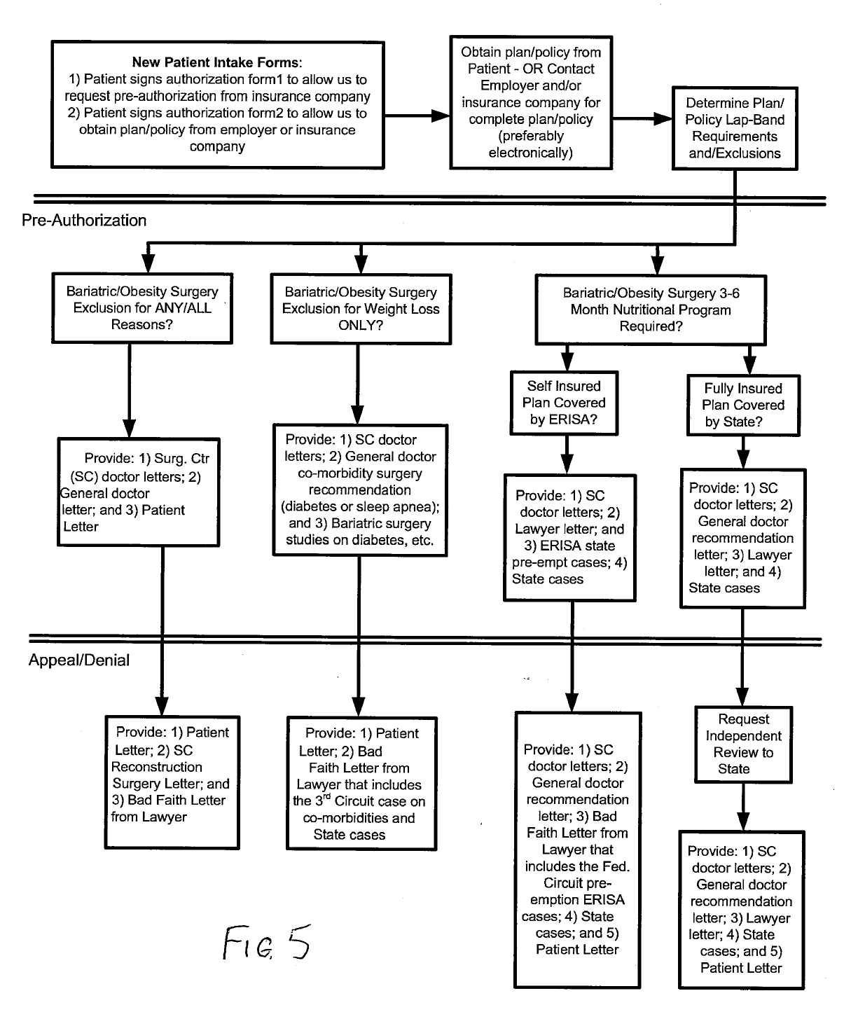

FIG. 5 shows a block diagram of a working example of an automated system and method for electronic verification, pre-certification and appeal for medical benefit denials of one embodiment of the present invention. FIG. 5 shows a working example of the present invention.

The foregoing has described the principles, embodiments and modes of operation of the present invention. However, the invention should not be construed as being limited to the particular embodiments discussed. The above described embodiments should be regarded as illustrative rather than restrictive, and it should be appreciated that variations may be made in those embodiments by workers skilled in the art without departing from the scope of the present invention as defined by the following benefits.

What is claimed is:

1. An automated system and method for electronic verification, pre-certification and appeal for medical benefit denials for providing automated medical processing to a medical or surgery center or other form of medical facility including a database software system to record, store and process large volumes of data and modules that automatically perform the processing task include preparations and automatically filing appeals for denials
